(19) United States
(12) Patent Application Publication
(10) Pub. No.: US 2016/0266767 A1
(43) Pub. Date: Sep. 15, 2016

(54) INFORMATION DISPLAY DEVICE AND INFORMATION DISPLAY METHOD

(71) Applicant: MITSUBISHI ELECTRIC CORPORATION, Tokyo (JP)

(72) Inventors: Takehisa MIZUGUCHI, Tokyo (JP); Yoshihiko MORI, Tokyo (JP); Yoshiaki WATANABE, Tokyo (JP); Hiroyuki YOKOTA, Kobe-shi (JP); Takeshi MITSUI, Tokyo (JP); Tsutomu MATSUBARA, Tokyo (JP); Masato HIRAI, Tokyo (JP); Masami AIKAWA, Tokyo (JP); Masahiro KOSAKADA, Tokyo (JP); Masakazu OKUDA, Tokyo (JP)

(73) Assignee: MITSUBISHI ELECTRIC CORPORATION, Tokyo (JP)

(21) Appl. No.: 15/034,374

(22) PCT Filed: Nov. 5, 2013
(86) PCT No.: PCT/JP2013/079887

§ 371 Date: May 4, 2016

(51) Int. Cl. G06F 3/0481; G06T 13/80; G06F 3/01; G06F 3/0482

(52) U.S. Cl. CPC G06F 3/04817; G06F 3/0482; G06T 13/80; G06F 3/013; G06T 2200/24

(57) ABSTRACT

When three warnings (a brake abnormality, a charging abnormality and an oil pressure reduction) occur in a vehicle, a brake abnormality icon, a charging abnormality icon and an oil pressure reduction icon are displayed in an icon displaying region of a display. On the other hand, brake abnormality warning information, charging abnormality warning information and oil pressure reduction warning information are displayed, in an information displaying region, in a switching manner every fixed time period.

### FIELD OF THE INVENTION

The present invention relates to an information display device and an information display method capable of displaying plural pieces of information.

### BACKGROUND OF THE INVENTION

In the instrument panel of a vehicle, when there is a warning which should be notified to the driver, an icon-shaped warning light is switched on to notify the warning to the driver. However, because there are many types of warning lights in the vehicle, the driver doesn't necessarily have a memory of the meanings of all the warning lights. Therefore, there is a case in which even if the driver only looks at the display of a small icon, he or she does not understand what type of warning the icon means.

On the other hand, there have been provided information display devices each of which displays a warning on a liquid crystal display mounted in an instrument panel or an HUD (head-up display) using a front window (for example, refer to patent references 1 to 3). In this case, because the information display device can display the details of a warning in a large display area, there is provided an advantage of being able to intelligibly display the warning for the driver as compared with warning lights having a small icon shape.

### RELATED ART DOCUMENT

### Patent Reference

Patent reference 1: Japanese Unexamined Patent Application Publication No. 2008-1120

Patent reference 2: Japanese Unexamined Patent Application Publication No. 2009-196594

Patent reference 3: Japanese Unexamined Patent Application Publication No. 2003-291688

### SUMMARY OF THE INVENTION

### Problems to be Solved by the Invention

Even in the case of the information display devices as disclosed in above-mentioned patent references 1 to 3, the display area is insufficient for displaying many warnings simultaneously. Although a method of displaying each of a plurality of warnings at constant intervals in a switching manner can be considered as a measure, there is a problem that the driver cannot recognize that there are a plurality of warnings only by looking at the display of the warnings for a moment.

The present invention is made in order to solve the above-mentioned problems, and it is therefore an object of the present invention to provide an information display device and an information display method that intelligibly display the total number of pieces of information and the descriptions of the pieces of information in a limited display area.

### Means for Solving the Problem

According to the present invention, there is provided an information display device including: a display having an information displaying region in which information can be displayed, and an icon displaying region in which an icon showing, in a graphic form, descriptions of the above-mentioned information can be displayed; and a controller to cause, when the number of pieces of information is larger than a set number, the above-mentioned pieces of information to be displayed, in the information displaying region, in units of the set number in a switching manner, and cause, when the above-mentioned number of pieces of information is equal to or smaller than the set number, all of the above-mentioned pieces of information to be displayed in the information displaying region, while to cause all icons respectively correlated with the above-mentioned pieces of information to be displayed in the icon displaying region regardless of the above-mentioned number of pieces of information.

According to the present invention, there is provided an information display device including: a first display having an information displaying region in which information can be displayed; a second display having an icon displaying region in which an icon showing, in a graphic form, descriptions of the information can be displayed; a first controller to cause, when the number of pieces of information is larger than a set number, the above-mentioned pieces of information to be displayed, in the information displaying region, in units of the set number in a switching manner, and, when the above-mentioned number of pieces of information is equal to or smaller than the set number, display all of the above-mentioned pieces of information in the information displaying region; and a second controller to cause all icons respectively correlated with the above-mentioned pieces of information to be displayed in the icon displaying region regardless of the number of pieces of information.

According to the present invention, there is provided an information display method of controlling display of a display having an information displaying region in which information can be displayed, and an icon displaying region in which an icon showing, in a graphic form, descriptions of the above-mentioned information can be displayed, the information display method including the step of, in a controller, causing, when the number of pieces of information is larger than a set number, the above-mentioned pieces of information to be displayed, in the information displaying region, in units of the set number in a switching manner, and causing, when the above-mentioned number of pieces of information is equal to or smaller than the set number, all of the above-mentioned pieces of information to be displayed in the information displaying region, while causing all icons respectively correlated with the above-mentioned pieces of information to be displayed in the icon displaying region regardless of the above-mentioned number of pieces of information.

### Advantages of the Invention

According to the present invention, a plurality of icons correlated with plural pieces of information are displayed in the icon displaying region, thereby allowing the user to easily recognize the total number of pieces of information. Further, the plural pieces of information are displayed in the information displaying region in a switching manner, thereby making it possible to display the details of each information even though the display area is small, and allowing the user to easily grasp the descriptions of each information. In addition, the use is enabled to learn about a correlation between an icon and information, thereby enabling the user to grasp the descriptions of each of plural pieces of information only by looking at a corresponding icon displayed in the icon displaying region. Therefore, the information display device and the information display method make it possible to intelligibly display the total number of pieces of information and the descriptions of the pieces of information in a limited display area.

### BRIEF DESCRIPTION OF THE FIGURES

FIG. 1 is a diagram showing an example of a screen transition of a display of an information display device according to Embodiment 1 of the present invention;

FIG. 2 is a diagram showing an example of screen display of the display of the information display device according to Embodiment 1;

FIG. 3 is a block diagram showing the configuration of the information display device according to Embodiment 1;

FIG. 4 is a flow chart showing the operation of a controller of the information display device according to Embodiment 1;

FIG. 5 is a diagram showing a variant of the information display device according to Embodiment 1, and showing an example of a screen transition in a case of showing a correlation between warning information and an icon by using an animation;

FIG. 6 is a diagram showing a variant of the information display device according to Embodiment 1, and showing an example of screen display of the display in which a plurality of icon displaying regions are disposed;

FIG. 7 is a block diagram showing a variant of the information display device according to Embodiment 1;

FIG. 8 is a block diagram showing the configuration of an information display device according to Embodiment 2 of the present invention;

FIG. 9 is a diagram showing an example of the arrangement of two displays which the information display device according to Embodiment 2 has;

FIG. 10 is a diagram showing an example of screen display of the two displays of the information display device according to Embodiment 2; and

FIG. 11 is a flow chart showing the operations of two controllers of the information display device according to Embodiment 2.

### EMBODIMENTS OF THE INVENTION

Hereafter, in order to explain this invention in greater detail, the preferred embodiments of the present invention will be described with reference to the accompanying drawings.

### Embodiment 1

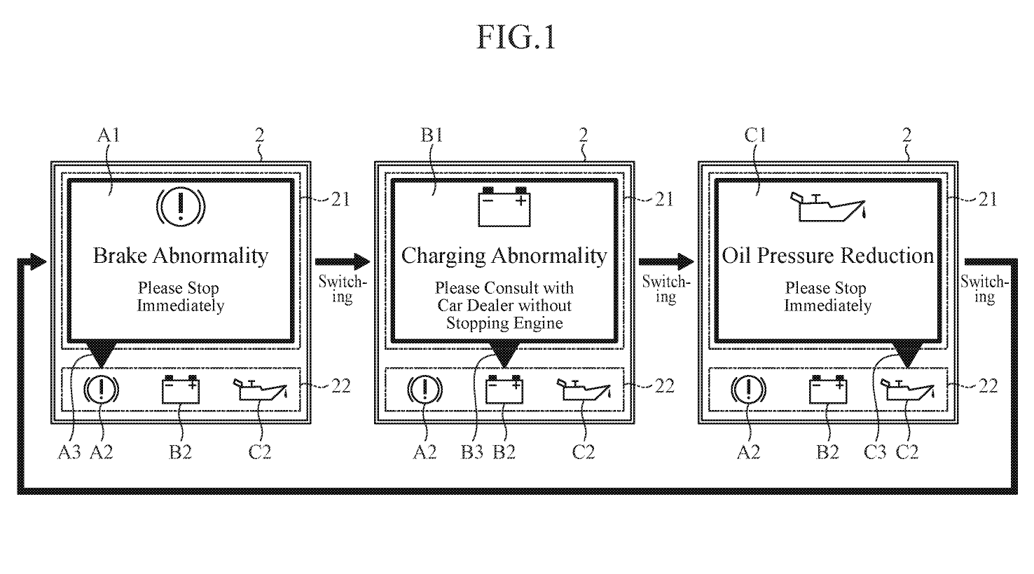

FIG. 1 is a diagram showing an example of a screen transition of a display 2 of an information display device 1 according to this Embodiment 1.

The display 2 is comprised of a liquid crystal display mounted in an instrument panel of a vehicle, an HUD using a front window, or the like. This display 2 includes an information displaying region 21 in which detailed information on a warning notified from the vehicle (referred to as warning information from here on) is displayed, and an icon displaying region 22 in which icons showing, in a graphic form, the descriptions of pieces of warning information are displayed.

When three types of warning information (a brake abnormality, a charging abnormality and an oil pressure reduction) are notified from the vehicle, brake abnormality warning information A1 showing the detailed descriptions of the brake abnormality, charging abnormality warning information B1 showing the detailed descriptions of the charging abnormality, and oil pressure reduction warning information C1 showing the detailed descriptions of the oil pressure reduction are displayed, in the information displaying region 21, in a switching manner every fixed time period.

By causing the display 2 to display only one type of warning information by using a large region, the descriptions of the information can be presented intelligibly to the driver.

On the other hand, a brake abnormality icon A2 showing, in a graphic form, the warning information on the brake abnormality, a charging abnormality icon B2 showing, in a graphic form, the warning information on the charging abnormality, and an oil pressure reduction icon C2 showing, in a graphic form, the warning information on the oil pressure reduction are displayed at all times in the icon displaying region 22.

By causing the display 2 to display the plurality of icons correlated with the pieces of warning information, the driver is enabled to easily recognize the number of warnings which have been issued.

In addition, while the brake abnormality warning information A1 is displayed in the information displaying region 21, a speech balloon A3 connecting between the brake abnormality warning information A1 and the brake abnormality icon A2, which are correlated with each other, is displayed. Similarly, while the charging abnormality warning information B1 is displayed in the information displaying region 21, a speech balloon B3 connecting between the charging abnormality warning information B1 and the charging abnormality icon B2 is displayed, and while the oil pressure reduction warning information C1 is displayed, a speech balloon C3 connecting between the oil pressure reduction warning information C1 and the oil pressure reduction icon C2 is displayed.

The information display device 1 displays the correlation between each warning information and the corresponding icon, thereby enabling the driver to learn about the warning information shown by the icon and, after having learned about the icon, come to understand the icon by simply looking at the icon when displayed. More specifically, the driver can understand the plural pieces of warning information by simply looking at the icons displayed in the icon displaying region 22.

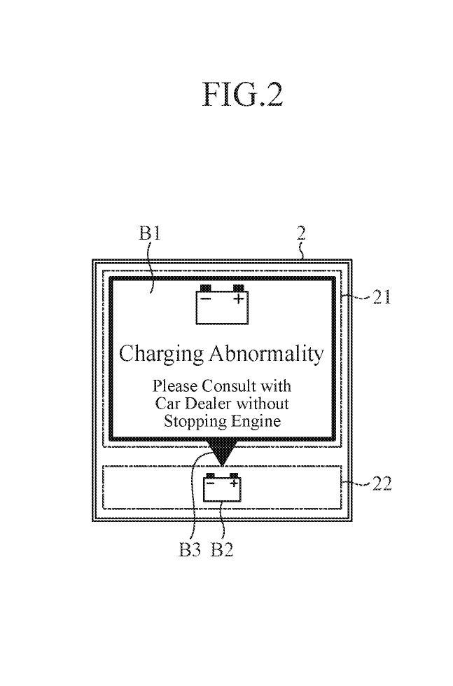

FIG. 2 is a diagram showing an example of screen display of the display 2. In this example, only one type of warning information (a charging abnormality) is notified from the vehicle. In this case, the charging abnormality warning information B1 is displayed in the information displaying region 21 at all times, and the charging abnormality icon B2 is displayed in the icon displaying region 22 at all times. Further, the speech balloon B3 showing the correlation between the charging abnormality warning information B1 and the charging abnormality icon B2 is also displayed at all times.

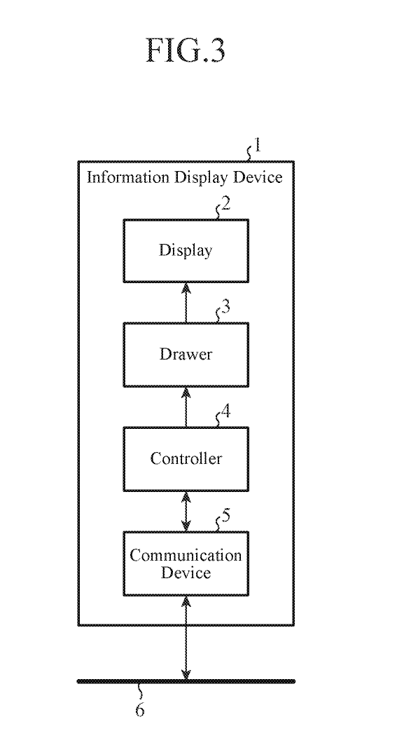

Next, the configuration of the information display device 1 will be explained by referring to a block diagram of FIG. 3.

The information display device 1 is mounted in a vehicle, and is comprised of a display 2, a drawer 3, a controller 4, a communication device 5, etc. The display 2 consists of a liquid crystal display, an HUD or the like, as mentioned above. The drawer 3 draws a video image to be displayed on the display 2. For example, the drawer consists of a GPU (Graphics Processing Unit) or the like. The controller 4 controls the operation performed by the whole of the information display device 1. Typically, the controller consists of a CPU (Central Processing Unit) or the like. The communication device 5 receives information, such as warning information, from the vehicle via a vehicle-mounted network 6 of the vehicle in which the information display device 1 is mounted.

Because the controller 4 manages the operation of this information display device 1, the operation will be explained with reference to the operation of this controller 4.

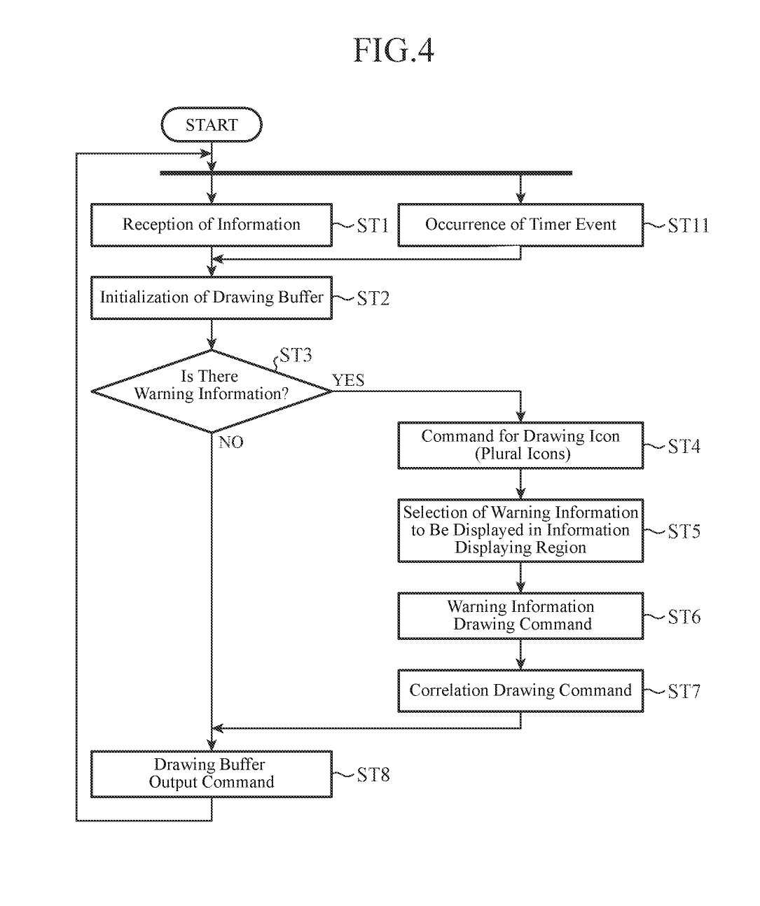

FIG. 4 is a flow chart showing the operation of the controller 4.

When receiving various pieces of information from the vehicle-mounted network 6 by way of the communication device 5 (step ST1), or when a timer event, which will be described below, occurs (step ST11), the controller 4 performs processes of subsequent steps ST2 to ST8. In step ST2, the controller 4 outputs a command for drawing buffer initialization to the drawer 3. The drawer 3 which has received the initialization command initializes a drawing buffer (not shown) for drawing the video image to be displayed on the display 2.

On the other hand, the controller 4 has a timer (not shown) that measures the time to change the warning information currently being displayed in the information displaying region 21, and generates a timer event every fixed time period. The controller 4 outputs a command for drawing buffer initialization (step ST2) whenever a timer event occurs (step ST11). The process of this step ST11 is performed in parallel to the processes of steps ST1 to ST8.

Next, the controller 4 checks whether or not warning information which is to be displayed on the display 2 is included in the various pieces of information received in step ST1 (step ST3). When no warning information is included in the various pieces of information (when “NO” in step ST3), the controller advances to step ST8. When warning information is included in the various pieces of information (when “YES” in step ST3), the controller 4 commands the drawer 3 to draw an icon correlated with the warning information onto the drawing buffer (step ST4). When plural pieces of warning information are included in the various pieces of information, the controller 4 commands the drawer to draw icons whose number is equal to the number of plural pieces of warning information. The drawer 3 which has received the command for drawing icon draws each icon in a region on the drawing buffer, the region corresponding to the icon displaying region 22.

As the icon drawing command in step ST4, there is, for example, a graphics drawing command or a bitmapped image drawing command. The graphics drawing command includes, as parameters, the coordinates of each of the vertices of each icon, and the fill color and the line color of each icon. The bitmapped image drawing command includes, as parameters, bitmap image data and a drawing position of each icon.

Graphics data etc. about each icon from which the graphics drawing command or the bitmapped image drawing command is made to originate are stored in a memory (not shown) or the like of the controller 4.

The controller 4 selects one warning information to be displayed in the information displaying region 21 (step ST5). When the number of pieces of warning information is one at the time of the check of step ST3, the warning information is uniquely determined, whereas when the number of pieces of warning information is two or more, the controller selects each warning information from the received pieces of information in such a way as to display warning information different for each fixed time period.

In the flow chart of FIG. 4, when a timer event of step ST11 occurs, the controller 4 changes the warning information currently being displayed in the information displaying region 21 by selecting different warning information in next step ST5.

Next, the controller 4 commands the drawer 3 to draw the selected warning information onto the drawing buffer (step ST6). The drawer 3 which has received the command for drawing warning information draws the warning information in the region on the drawing buffer, the region corresponding to the information displaying region 21.

As the warning information drawing command of step ST6, there is, for example, a graphics drawing command or a bitmapped image drawing command, like in the case of the icon drawing command of step ST4. Graphics data, text data, etc. about the warning information from which the graphics drawing command or the bitmapped image drawing command is made to originate are stored in the memory or the like of the controller 4.

Next, the controller 4 commands the drawer 3 to draw a speech balloon or the like in order to show a correlation between the icon correlated with the warning information selected in step ST5 and the warning information for which the drawing command is issued in step ST6 (step ST7). The drawer 3 which has received the command for drawing correlation draws a speech balloon connecting between the warning information and the icon correlated with the warning information onto the drawing buffer.

As the correlation drawing command of step ST7, there is, for example, a graphics drawing command or a bitmapped image command, like in the case of the icon drawing command of step ST4. For example, when expressing the correlation by using the speech balloon A3 of FIG. 1, the controller 4 outputs parameters including the coordinates of each of the vertices of a triangle serving as the speech balloon and the fill color of the triangle to the drawer 3.

Finally, the controller 4 commands the drawer 3 to transfer the image in the drawing buffer to the display 2 (step ST8). The drawer 3 which has received the image transfer command transfers the image in the drawing buffer to the display 2, and the display 2 displays the warning information, the icon and the speech balloon.

When no warning information is included in the received pieces of information (when “NO” in step ST3), nothing is displayed on the display 2 in step ST8.

As mentioned above, the information display device 1 according to Embodiment 1 is configured in such a way as to include the display 2 having the information displaying region 21 in which warning information can be displayed, and the icon displaying region 22 in which an icon showing, in a graphic form, the descriptions of that warning information can be displayed, and the controller 4 that causes, when there are plural pieces of warning information, a plurality of icons correlated with that plural pieces of warning information to be displayed in the icon displaying region 22, and causes that plural pieces of warning information to be displayed in the information displaying region 21 in a switching manner. The plurality of icons correlated with the plural pieces of warning information are displayed in the icon displaying region 22, thereby allowing the driver to easily recognize the total number of warnings which have been issued. Further, the plural pieces of warning information are displayed in the information displaying region 21 in a switching manner, thereby making it possible to display the details of each warning information even though the display area is small, and allowing the driver to easily grasp the descriptions of each warning. In addition, the driver is enabled to learn about the correlations between the icons and the pieces of warning information, thereby enabling the user to grasp the descriptions of each warning only by looking at a corresponding icon displayed in the icon displaying region 22. Therefore, the information display device 1 can intelligibly display the total number of warnings and the descriptions of each warning in the limited display area.

Further, the controller 4 according to Embodiment 1 is configured in such a way as to cause the correlation between the warning information in the information displaying region 21 and the icon displayed in the icon displaying region 22 and correlated with that warning information to be displayed. For example, the controller shows the correlation by connecting between the warning information and the icon by using a speech balloon. Therefore, the driver can easily learn about the descriptions of the information shown by each icon displayed in the icon displaying region 22, and, when the display enters a mode of displaying only icons, the driver can recognize what each of the icons means.

Although the example in which the correlation between the warning information currently being displayed in the information displaying region 21 and an icon currently being displayed in the icon displaying region 22 is shown by using a speech balloon is shown in above-mentioned Embodiment 1, this embodiment is not limited to this example. For example, the correlation can be alternatively shown by using a graphic, such as a line or an arrow, connecting between the warning information and the icon.

As an alternative, the correlation can be shown by using an animation (display of a moving image) at the time of switching the warning information currently being displayed in the information displaying region 21 to other warning information.

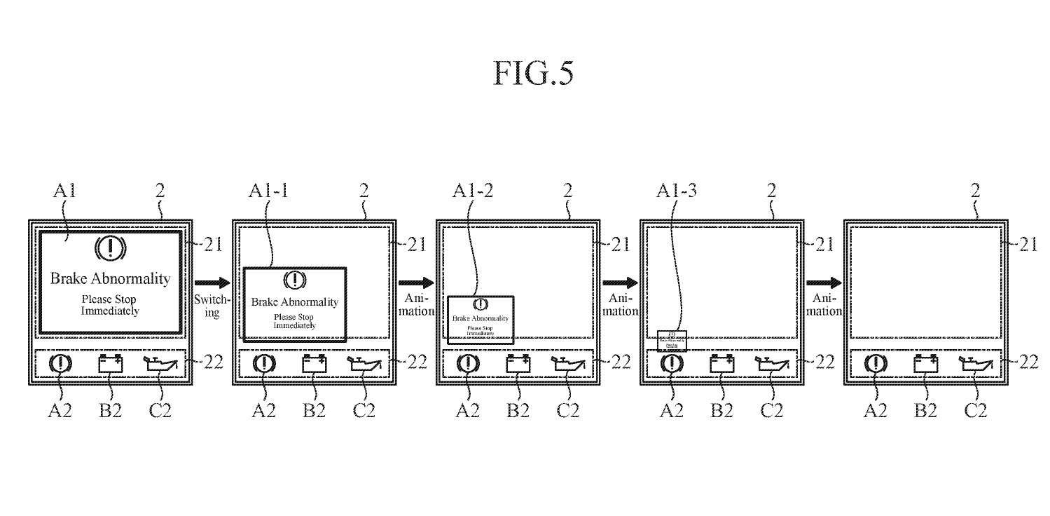

An example of a screen transition in the case of showing the correlation between warning information and an icon by using an animation is shown in FIG. 5. When switching the brake abnormality warning information A1 currently being displayed in the information displaying region 21 of the display 2 to the charging abnormality warning information B1 which is the next warning information, the controller 4 issues a command for drawing to the drawer 3 so as to gradually scale down the brake abnormality warning information A1 while moving the brake abnormality warning information from the information displaying region 21 toward the brake abnormality icon A2 in the icon displaying region 22. As a result, the animation looks as if the brake abnormality warning information A1 is scaled down gradually while being moved, in such a way that pieces of warning information A1-1, A1-2, and A1-3 are displayed in a sequential manner, and is finally swallowed up in the brake abnormality icon A2, so that the correlation between the brake abnormality warning information A1 and the brake abnormality icon A2 is clarified.

Further, the charging abnormality icon B2 can be animated when switching the display from the brake abnormality warning information A1 to the charging abnormality warning information B1. In the case of animating the charging abnormality icon B2, the controller 4 issues a drawing command to the drawer 3 to, for example, gradually scale up the charging abnormality warning information B1 while moving the charging abnormality warning information from the charging abnormality icon B2 in the icon displaying region 22 toward the information displaying region 21. As a result, the correlation between the charging abnormality warning information B1 and the charging abnormality icon B2 is clarified.

In the case of animating warning information to be displayed in the information displaying region 21, the controller 4, in step ST6 of FIG. 4, repeatedly outputs a warning information drawing command to change the graphic size and the drawing position of the warning information step by step. Further, in this case, no command for drawing correlation (a speech balloon or the like) in step ST7 is outputted.

In addition, when switching the display from the brake abnormality warning information A1 to the charging abnormality warning information B1, the correlation with the warning information can be enhanced by changing the display mode of the brake abnormality icon A2. For example, while the animation in FIG. 5 showing that the brake abnormality warning information A1 is swallowed up in the brake abnormality icon A2 is displayed or after the animation is displayed, the controller 4 blinks the brake abnormality icon A2, changes the brightness or the color of the brake abnormality icon A2, or displays an animation of, for example, rotating the brake abnormality icon A2. As a result, the driver is allowed to recognize the correlation between the warning information and the icon more easily.

Also when showing the correlation between warning information and an icon by using a graphic such as a speech balloon, the controller can blink the icon, change the brightness or the color of the icon, or display an animation at the time of switching the warning information to other warning information.

Further, although the icon displaying region 22 is disposed below the information displaying region 21 in above-mentioned Embodiment 1, the icon displaying region 22 can be alternatively disposed at another location.

In addition, the region in which an icon is displayed can be changed according to the type of warning information.

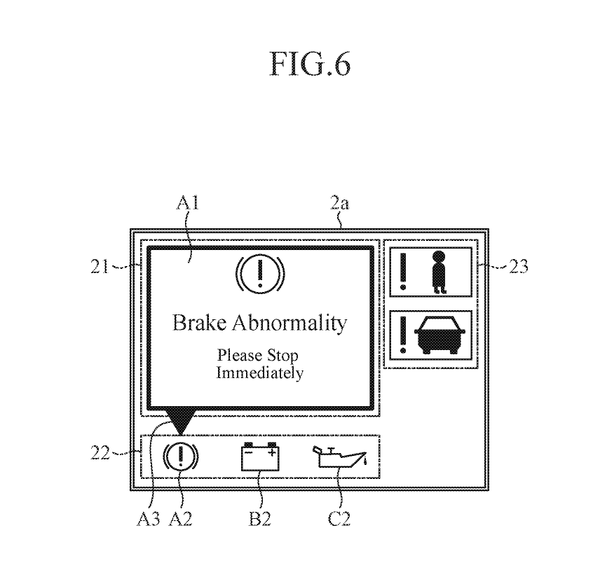

An example of screen display of a display 2a in which a plurality of icon displaying regions 22 and 23 are disposed is shown in FIG. 6. The display 2a includes the icon displaying region 22 in which icons showing pieces of warning information on failures of the vehicle (e.g., a brake abnormality) are displayed, the icon displaying region 23 in which icons showing pieces of warning information on the surroundings of the vehicle (e.g., detection of an obstacle) are displayed, and an information displaying region 21 in which those pieces of warning information are displayed in a switching manner. The controller 4 determines the type of warning information received by way of the vehicle-mounted network 6, and causes the icon showing the warning information to be displayed in the icon displaying region 22 or the icon displaying region 23.

As a result, the driver is allowed to easily determine the type of the warning on the basis of the display position of the icon.

Further, although the example of, when there are plural pieces of warning information to be displayed in the information displaying region 21, switching the display among pieces of warning information every fixed time period is explained in above-mentioned Embodiment 1, the display can be switched among pieces of warning information by using another method.

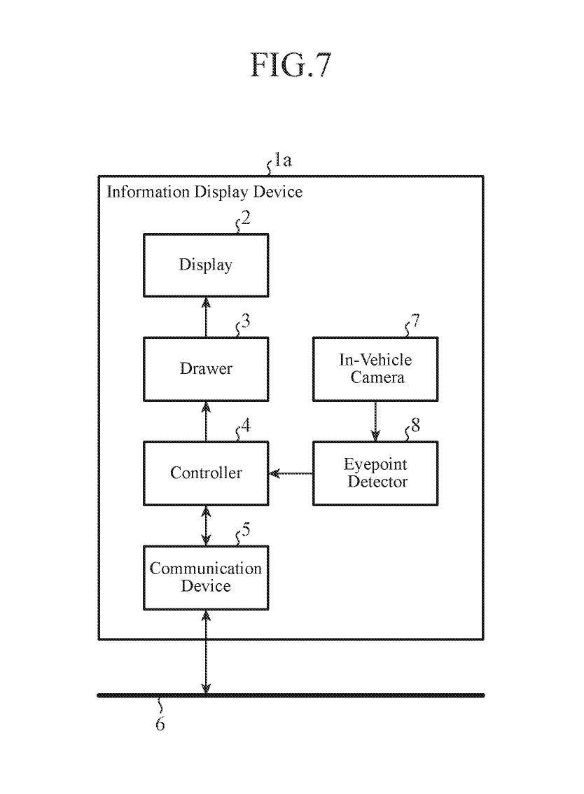

An example of the configuration of an information display device 1a is shown in FIG. 7. In the information display device 1a, an in-vehicle camera 7 that captures an image of the driver, and an eyepoint detector 8 that analyzes the captured image and detects the eyepoint of the driver are additionally disposed. As an alternative, instead of having the in-vehicle camera 7, the information display device 1a can acquire a captured image from an in-vehicle camera mounted in the vehicle by way of the vehicle-mounted network 6. Further, the eyepoint detecting method of the eyepoint detector 8 is not limited to the method of using the captured image.

The controller 4 determines that the warning information has been already read when determining that the driver has looked at the information displaying region 21 for a fixed time period or more or a fixed number of times or more on the basis of the information on the eyepoint detected by the eyepoint detector 8, and ends the display of the warning information in the information displaying region 21 or switches the display from the warning information to other warning information.

As a result, the information display device can prevent the information displaying region 21 from being occupied by the warning information which has been already read to prevent other information from not being displayed.

As an alternative, in the information display device 1a of FIG. 7, when determining that the driver has looked at a specific icon currently being displayed in the icon displaying region 22 for a fixed time period or more or a fixed number of times or more on the basis of the information on the eyepoint detected by the eyepoint detector 8, the controller 4 can determine that the icon attracts the driver's interest, and cause the warning information correlated with the icon to be displayed in the information displaying region 21.

### Embodiment 2

In above-mentioned Embodiment 1, the configuration in which the single information display device 1 draws and displays the information displaying region 21 and the icon displaying region 22 is explained. In contrast with this, in this Embodiment 2, a configuration in which with different information display devices 1 implement an information displaying region 21 and an icon displaying region 22 respectively will be explained.

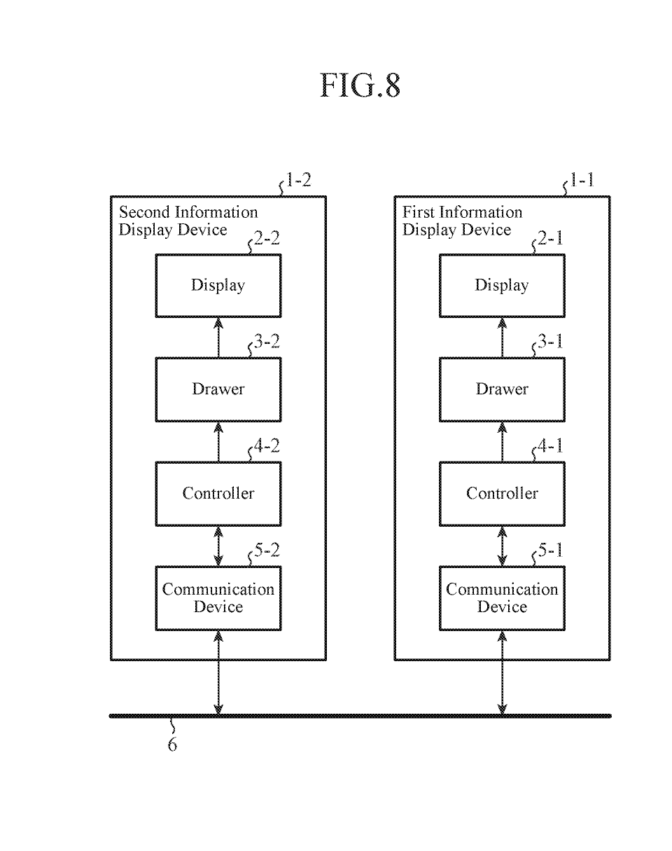

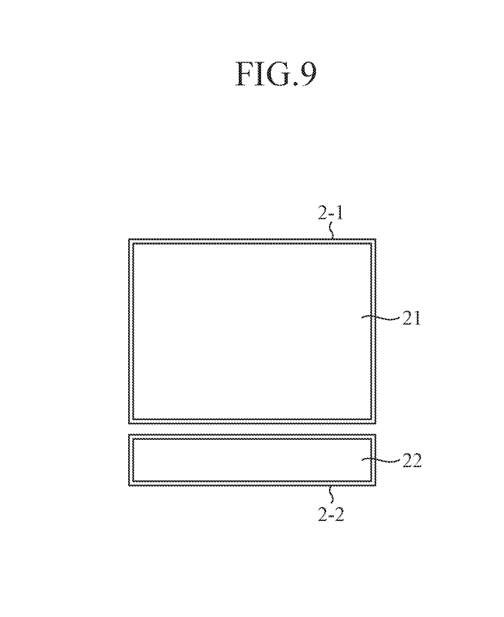

FIG. 8 is a block diagram showing the configuration of the information display devices 1-1 and 1-2 according to this Embodiment 2. FIG. 9 is a diagram showing an example of the arrangement of a display 2-1 of the information display device 1-1 and a display 2-2 of the information display device 1-2. In this Embodiment 2, the display 2-1 is used as the information displaying region 21, and the display 2-2 is used as the icon displaying region 22.

Accordingly, a drawer 3-1 and a controller 4-1 mainly take charge of drawing and display of warning information, while a drawer 3-2 and a controller 4-2 mainly take charge of drawing and display of icons. Therefore, the controller 4-1 holds graphics data, text data, etc. from which a command for drawing warning information (a graphics drawing command or a bitmapped image drawing command) is made to originate. On the other hand, the controller 4-2 holds graphics data etc. from which a command for icon drawing (a graphics drawing command or a bitmapped image drawing command) is made to originate. Further, it is assumed that an ID for identifying warning information and an icon which are correlated with each other is provided for each of those data held by the controllers 4-1 and 4-2.

In addition, the controllers 4-1 and 4-2 hold information for defining the positional relationship between the displays 2-1 and 2-2.

Further, the two information display devices 1-1 and 1-2 include communication devices 5-1 and 5-2, and can communicate with each other by way of a vehicle-mounted network 6 and further communicate with the vehicle by way of the vehicle-mounted network 6.

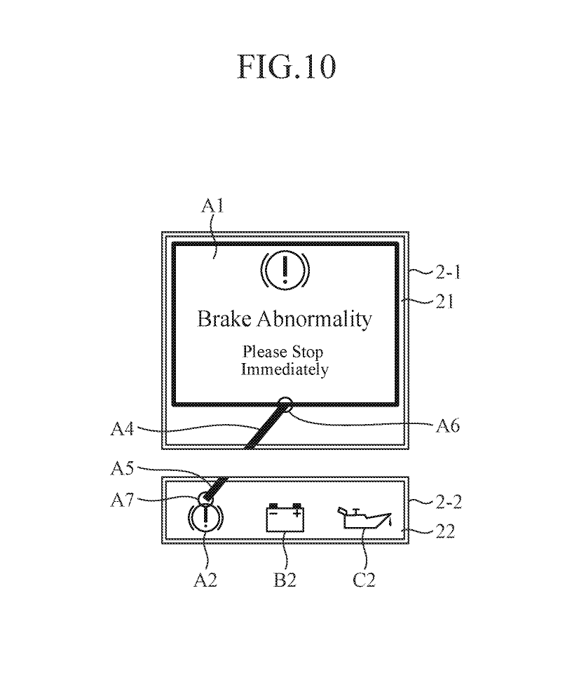

FIG. 10 is a diagram showing an example of screen display of the displays 2-1 and 2-2. Brake abnormality warning information A1 is displayed in the information displaying region 21 of the display 2-1, and a brake abnormality icon A2, a charging abnormality icon B2 and an oil pressure reduction icon C2 are displayed in the icon displaying region 22 of the display 2-2. In addition, a connecting line A4 showing a correlation between the brake abnormality warning information A1 and the brake abnormality icon A2 is displayed in the information displaying region 21 of the display 2-1, and a connecting line A5 showing a correlation between the brake abnormality warning information A1 and the brake abnormality icon A2 is displayed similarly in the icon displaying region 22 of the display 2-2. In the case in which the displays 2-1 and 2-2 are disposed as different components in this way, the correlation is shown by the set of connecting lines A4 and A5.

In this case, a position at which an end of the connecting line A4 is drawn in the information displaying region 21 (referred to as a correlation drawing position from here on) is expressed by A6 and a correlation drawing position at which an end of the connecting line A5 is drawn in the icon displaying region 22 is expressed by A7. The information display devices 1-1 and 1-2 draw and display the connecting lines A4 and A5 which connect between the drawing positions A6 and A7 in cooperation with each other, so that the correlation is shown while extending over the two screens of the brake abnormality warning information A1 and the brake abnormality icon A2.

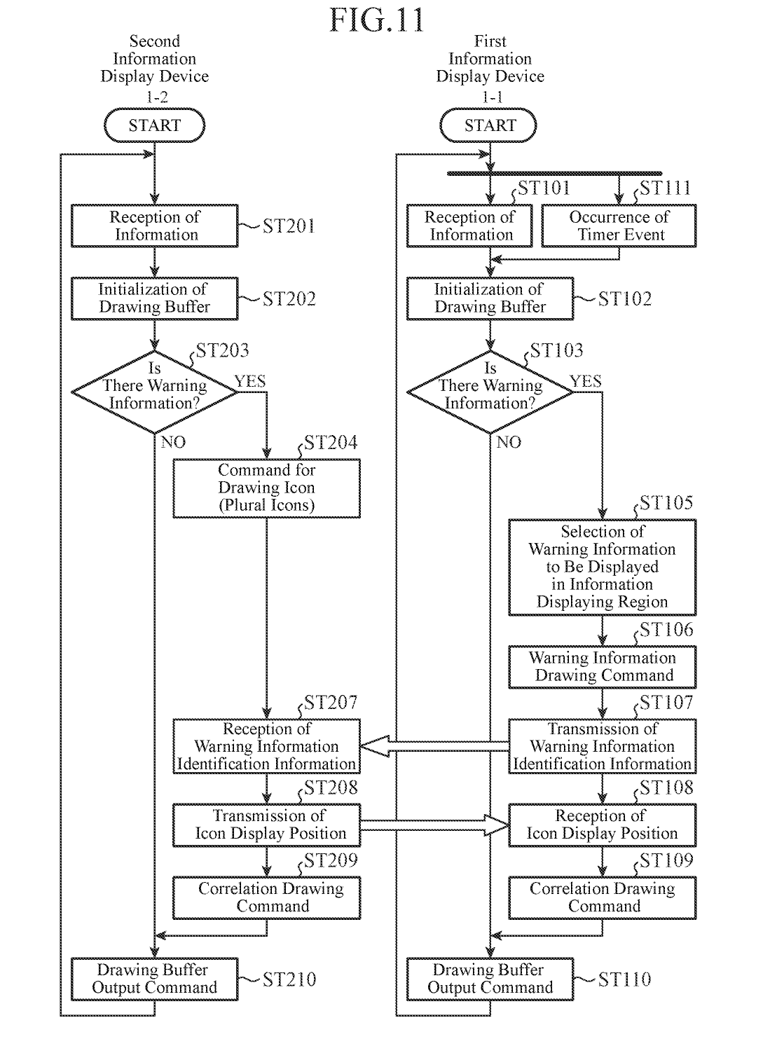

Next, the operations of the controllers 4-1 and 4-2 will be explained by referring to the flow chart of FIG. 11.

When receiving various pieces of information from the vehicle-mounted network 6 by way of the communication devices 5-1 and 5-2, the controllers 4-1 and 4-2 perform processes of subsequent steps ST102 to ST110 and ST202 to ST210 (steps ST101 and ST201). In steps ST102 and ST202, the controllers 4-1 and 4-2 output commands for drawing buffer initialization to the drawers 3-1 and 3-2. The drawers 3-1 and 3-2 which have received the commands for initialization initialize their respective drawing buffers (not shown) for drawing video images to be displayed on the displays 2-1 and 2-2.

Further, the controller 4-1 manages switching among pieces of warning information which are to be displayed in the information displaying region 21 according to a timer event, like the controller 4 according to above-mentioned Embodiment 1, and outputs a command for drawing buffer initialization to the drawer 3-1 (step ST102) whenever a timer event occurs every fixed time period (step ST111).

Next, the controllers 4-1 and 4-2 check whether or not warning information which is to be displayed on the displays 2-1 and 2-2 is included in the various pieces of information received in steps ST101 and ST201 (steps ST103 and ST203). When no warning information is included in the various pieces of information (when “NO” in step ST103 and “NO” in step ST203), the controllers advance to steps ST110 and ST210.

When one or more pieces of warning information are included in the various pieces of information (when “YES” in step ST203), the controller 4-2 commands the drawer 3-2 to draw the icons correlated with those pieces of warning information onto the drawing buffer (step ST204). The drawer 3-2 which has received the command for icon drawing draws the icons onto the drawing buffer.

On the other hand, when one or more pieces of warning information are included in the various pieces of information (when “YES” in step ST103), the controller 4-1 selects one warning information to be displayed in the information displaying region 21 (step ST105). Because a method of selecting one warning information is the same as that according to above-mentioned Embodiment 1, the explanation of the method will be omitted hereafter.

Next, the controller 4-1 commands the drawer 3-1 to draw the selected warning information onto the drawing buffer (step ST106). The drawer 3-1 which has received the command for drawing warning information draws the warning information onto the drawing buffer.

Next, the controller 4-1 transmits both the ID for identifying the warning information selected in step ST105 and the coordinates of the correlation drawing position (A6 shown in FIG. 10) for drawing the connecting line showing the correlation between the warning information and the icon, as warning information identification information, to the information display device 1-2 by way of the communication device 5-1 (step ST107).

The controller 4-2 receives the warning information identification information by way of the communication device 5-2 (step ST207), and determines the icon corresponding to the ID included in the warning information identification information.

Next, the controller 4-2 transmits the display position of the icon corresponding to the ID, i.e., the coordinates of the correlation drawing position (A7 shown in FIG. 10) for drawing the connecting line showing the correlation with the warning information to the information display device 1-1 by way of the communication device 5-2 (step ST208).

Next, the controller 4-2 commands the drawer 3-2 to draw the connecting line (A5 shown in FIG. 10) extending from the display position (A7 shown in the figure) of the icon corresponding to the ID, among the icons to be displayed on the display 2-2, toward the coordinates (A6 in the figure) included in the received warning information identification information (step ST209). The drawer 3-2 which has received the command for drawing connecting line draws the connecting line onto the drawing buffer.

The controller 4-1 receives the information on the display position of the icon by way of the communication device 5-1 (step ST108).

Next, the controller 4-1 commands the drawer 3-1 to draw the connecting line (A4 shown in FIG. 10) extending from the correlation drawing position (A6 shown in the figure) of the warning information to be displayed on the display 2-1 toward the display position (A7 shown in the figure) of the received icon (step ST109). The drawer 3-1 which has received the command for drawing connecting line draws the connecting line onto the drawing buffer.

Finally, the controllers 4-1 and 4-2 command the drawers 3-1 and 3-2 to transfer the images in their respective drawing buffers to the displays 2-1 and 2-2 (steps ST110 and ST210). The drawer 3-1 which has received the transfer command for image transfers the image in the drawing buffer to the display 2-1, and displays the warning information and the connecting line in the information displaying region 21. Further, the drawer 3-2 which has received the transfer command for image transfers the image in the drawing buffer to the display 2-2, and displays the one or more icons and the one connecting line in the icon displaying region 22.

As mentioned above, according to Embodiment 2, there is provided a configuration in which two information display devices are used, and one information display device 1-1 includes a display 2-1 having an information displaying region in which warning information can be displayed, and a controller 4-1 that, when there are plural pieces of warning information, causes the plural pieces of warning information to be displayed in the information displaying region 21 in a switching manner, while the other information display device 1-2 includes a display 2-2 having an icon displaying region 22 in which an icon showing, in a graphic form, the descriptions of warning information can be displayed, and a controller 4-1 that, when there are plural pieces of warning information, causes the plurality of icons respectively correlated with those plural pieces of warning information to be displayed in the icon displaying region 22. Therefore, the information display devices 1-1 and 1-2 intelligibly display the total number of warnings and the descriptions of the warnings in a limited display area, like that according to above-mentioned Embodiment 1.

Further, according to Embodiment 2, the controller 4-1 is configured in such a way as to notify warning information to be displayed in the information displaying region 21 to the controller 4-2, receive the display position in the icon displaying region 22 of the icon correlated with that warning information from the controller 4-2, and cause the display 2-1 to display the correlation between the warning information in the information displaying region 21 and the icon in the icon displaying region 22 on the basis of that display position, and the controller 4-2 is configured in such a way as to, when receiving warning information to be displayed in the information displaying region 21 from the controller 4-1, notify the display position in the icon displaying region 22 of the icon correlated with that warning information to the controller 4-1, and cause the display 2-2 to display the correlation. Therefore, even when the information displaying region 21 and the icon displaying region 22 are constructed in different units, the information display device 1-1 can perform drawing and display of correlations with the information display device 1-2. Similarly, the information display device 1-2 can perform drawing and display of correlations with the information display device 1-1.

Although in above-mentioned Embodiment 2 the information display device is configured in such a way to display correlations both in the information displaying region 21 and in the icon displaying region 22, the information display device can be alternatively configured in such a way as to display correlations in either one of the information displaying region and the icon displaying region.

Further, although the case in which the display 2-2 of the information display device 1-2 consists of a liquid crystal display or the like and icons are displayed in the icon displaying region 22 is explained in above-mentioned Embodiment 2, the display 2-2 can alternatively consist of LEDs (Light Emitting Diodes) or the likes, which are cheaper than liquid crystal displays, and one LED can be switched on instead of displaying each icon.

Further, also in above-mentioned Embodiment 2, a correlation between each warning information and an icon can be shown by either a speech balloon, an arrow or the like, or an animation at the time of switching the warning information currently being displaying in the information displaying region to other warning information, like in the case of above-mentioned Embodiment 1. In addition, by changing the display mode of the icon when switching between pieces of warning information, the correlation can be enhanced.

Further, also in above-mentioned Embodiment 2, an in-vehicle camera 7 and an eyepoint detector 8 can be added, and the display of warning information can be switched on the basis of eyepoint information on the driver, like in the case of the information display device 1a of FIG. 7.

In addition, although in above-mentioned Embodiments 1 and 2 the information display device is configured in such a way to set the set number of pieces of warning information displayed in the information displaying region 21 to 1, and, when there are two or more pieces of warning information, sequentially display the pieces of warning information one by one in the information displaying region 21 in a switching manner, the set number can be arbitrary. For example, in the case in which the set number is set to 2, when there are three or more pieces of warning information, the information display device displays the pieces of warning information two by two in the information displaying region 21 in a switching manner, and, when there are two or less pieces of warning information, displays all the pieces of warning information at one time in the information displaying region 21.

While the present invention has been described in its preferred embodiments, it is to be understood that, in addition to the above-mentioned embodiments, an arbitrary combination of two or more of the embodiments can be made, various changes can be made in an arbitrary component according to any one of the embodiments, and an arbitrary component according to any one of the embodiments can be omitted within the scope of the invention.

### INDUSTRIAL APPLICABILITY

As mentioned above, because the information display device and the information display method according to the present invention are configured in such a way as to display pieces of information in the information displaying region in a switching manner while displaying all icons in the icon displaying region, the information display device and the information display method are suitable for use as and in an information display device or the like that is mounted in the instrument panel of a vehicle and notifies warnings to the driver. Needless to say, the application of the information display device and the information display method is limited to the instrument panel of a vehicle, and the information display device and the information display method can be applied to a display device of home electronics, and so on.

### EXPLANATIONS OF REFERENCE NUMERALS

1, 1a, 1-1, 1-2 information display device, 2, 2a, 2-1, 2-2 display, 3, 3-1, 3-2 drawer, 4, 4-1, 4-2 controller, 5, 5-1, 5-2 communication device, 6 vehicle-mounted network, 7 in-vehicle camera, 8 eyepoint detector, 21 information displaying region, 22, 23 icon displaying region, A1 brake abnormality warning information, A2 brake abnormality icon, A3 speech balloon, A4, A5 connecting line, A6, A7 correlation drawing position, B1 charging abnormality warning information, B2 charging abnormality icon, B3 speech balloon, C1 oil pressure reduction warning information, C2 oil pressure reduction icon, and C3 speech balloon.

1-16. (canceled)

17. An information display device comprising:
a communication device to receive information; and
a controller to cause, when a number of pieces of information which are included in the received information and are to be displayed in a display is larger than a set number, the pieces of information to be displayed to be displayed, in an information displaying region of said display in which said information can be displayed, in units of said set number in a switching manner, and cause, when the number of pieces of information to be displayed is equal to or smaller than said set number, all of said the pieces of information to be displayed to be displayed in said information displaying region, while to cause all icons respectively correlated with the pieces of information to be displayed in an icon displaying region of said display in which an icon showing, in a graphic form, descriptions of said information can be displayed regardless of the number of pieces of information to be displayed,
wherein when switching information currently being displayed in said information displaying region to other information, said controller gradually scales down said displayed information while moving said information from said information displaying region toward an icon displayed in said icon displaying region and correlated with said information, or scales up said other information while moving said other information from an icon displayed in said icon displaying region and correlated with said other information toward said information displaying region.

18. The information display device according to claim 17, wherein said controller shows a correlation between information currently being displayed in said information displaying region and an icon displayed in said icon displaying region and correlated with said information by connecting, in a graphic form, between the information currently being displayed in said information displaying region and the icon displayed in said icon displaying region and correlated with said information.

19. The information display device according to claim 17, wherein said display has a plurality of icon displaying regions respectively corresponding to information types, and said controller switches among said icon displaying regions in each of which icons are displayed according to a type of each of said pieces of information.

20. The information display device according to claim 17, wherein when switching the information currently being displayed in said information displaying region to other information, during or after a time interval that said controller gradually scales down said displayed information while moving said information from said information displaying region toward the icon displayed in said icon displaying region and correlated with said information, said controller performs at least one of blinking of said correlated icon, changing of brightness of said correlated icon, changing of a color of said correlated icon, and display of an animation about said correlated icon.

21. The information display device according to claim 17, wherein said controller shows a correlation between information currently being displayed in said information displaying region and an icon displayed in said icon displaying region and correlated with said information by performing at least one of blinking of the icon correlated with the information currently being displayed in said information displaying region, changing of brightness of said correlated icon, changing of a color of said correlated icon, and display of an animation about said correlated icon.

22. The information display device according to claim 17, wherein said information display device includes an eyepoint detector to detect a user's eyepoint, and, when determining that said user has looked at the information currently being displayed in said information displaying region for a fixed time or more or a fixed number of times or more on a basis of information on the eyepoint detected by said eyepoint detector, said controller switches the information to other information.

23. The information display device according to claim 17, wherein said information display device includes an eyepoint detector to detect a user's eyepoint, and, when determining that said user has looked at an icon currently being displayed in said icon displaying region for a fixed time or more or a fixed number of times or more on a basis of information on the eyepoint detected by said eyepoint detector, said controller displays information correlated with said icon in said information displaying region.

24. The information display device according to claim 17, wherein said display is comprised of a liquid crystal display mounted in an instrument panel of a vehicle, or a head-up display using a front window.

25. The information display device according to claim 17, wherein said display includes a first display having said information displaying region and a second display having said icon displaying region, and said controller includes a first controller to cause, when the number of pieces of information is larger than the set number, said pieces of information to be displayed, in said information displaying region, in units of said set number in a switching manner, and, when said number of pieces of information is equal to or smaller than said set number, display all of said pieces of information in said information displaying region, and a second controller to cause all icons respectively correlated with said pieces of information to be displayed in said icon displaying region regardless of the number of pieces of information.

26. The information display device according to claim 25, wherein said first controller notifies information to be displayed in said information displaying region to said second controller, receives a display position in said icon displaying region of an icon correlated with said information from said second controller, and causes said first display to display a correlation between the information in said information displaying region and the icon in said icon displaying region on a basis of said display position, and wherein when receiving the information to be displaying in said information displaying region from said first controller, said second controller notifies the display position in said icon displaying region of the icon correlated with said information to said first controller.

27. The information display device according to claim 25, wherein said first controller notifies information to be displayed in said information displaying region to said second controller, and, when receiving the information to be displaying in said information displaying region from said first controller, said second controller causes said second display to display a correlation between said information and an icon in said icon displaying region.

28. The information display device according to claim 25, wherein said second display is configured using an LED (Light Emitting Diode), and switches on said LED instead of displaying said icon.

29. An information display method of controlling display of a display having an information displaying region in which information can be displayed, and an icon displaying region in which an icon showing, in a graphic form, descriptions of said information can be displayed, said information display method comprising the steps of:
in a communication device, receiving information; and
in a controller, causing, when a number of pieces of information which are included in the received information and are to be displayed in the display is larger than a set number, the pieces of information to be displayed to be displayed, in said information displaying region, in units of said set number in a switching manner, and causing, when the number of pieces of information to be displayed is equal to or smaller than said set number, all of said pieces of information to be displayed to be displayed in said information displaying region, while causing all icons respectively correlated with the pieces of information to be displayed in said icon displaying region regardless of the number of pieces of information to be displayed, and, when switching information currently being displayed in said information displaying region to other information, gradually scaling down said displayed information while moving said information from said information displaying region toward an icon displayed in said icon displaying region and correlated with said information, or scaling up said other information while moving said other information from an icon displayed in said icon displaying region and correlated with said other information toward said information displaying region.
